(19) United States
(12) Patent Application Publication
(10) Pub. No.: US 2005/0172493 A1
(43) Pub. Date: Aug. 11, 2005

(54) Razor and method for producing a razor

(75) Inventors: Franz Fischer, Triengen (CH); Philipp Pfenniger, Triengen (CH)

Correspondence Address: OLIFF & BERRIDGE, PLC, P.O. BOX 19928, ALEXANDRIA, VA, 22320, US

(73) Assignee: Trisa Holding AG, Triengen (CH)

(21) Appl. No.: 10/807,281

(22) Filed: Mar. 24, 2004

(30) Foreign Application Priority Data
Feb. 11, 2004 (EP) 04 003 038.9

(51) Int. Cl. B26B 21/14

(52) U.S. Cl. 30/45

(57) ABSTRACT

The invention relates to a razor, in particular for wet shaving, with a body comprising a handle region (10), a head region (14) and a neck region (12) located between the handle region (10) and the head region (14), and with functional components which are at least partly arranged within the body and comprise an electrically operated vibration device (20) for producing vibrations in the head region and an electrical supply device, having an energy store (24), for the vibration device (20). According to the invention, the body comprises at least one hard component (16), serving as a reinforcement, and at least one soft component (18), produced by the injection-molding process, at least some of the functional components being at least partly encapsulated directly with the soft component (18). The invention also relates to a method for producing such a razor.

The invention relates to a razor, in particular a wet razor, with an electrical vibration unit and to a method for producing such a razor according to claims 1 and 21, respectively.

In the production of such razors, what is important in particular is that the functional components arranged inside the body are correctly positioned and that a save and reliable mode of operation is ensured. Since such razors are usually produced in large numbers, it is also intended for production to be possible in a low-cost and efficient mass production process. Since, furthermore, the outer appearance of the razors increasingly plays a not insignificant part in influencing the purchasing decision, it is intended that the construction of the razors should allow the greatest possible freedom of design, which must be taken into account in the production of the razors. This is dependent not only on creating an ergonomically advantageous razor but also on the requirement that the razor must be simple to operate, can be safely held securely during use and have a satisfactory surface with a pleasant feel.

A wet razor with an electrical vibration unit is known for example from U.S. Pat. No. 5,299,354. The wet razor comprises a body with a head region, which carries the razor blade unit, and a handle region. The head region and the handle region comprise multiple parts and are connected to one another in such a way they are secure from twisting. In the head region there is adhesively fixed a motor with an eccentric. The energy supply takes place by means of a battery, which is arranged in a cavity in the handle region. It is connected to the motor via lines which are routed through an insulator with channels.

A similar wet razor is known from U.S. Pat. No. 5,046,249. Here, the head region and the handle region are connected to one another by means of a flexible damping part, which has a clearance for lines to pass through.

The known wet razors comprise a multiplicity of individual parts, in particular the head region and a separate handle region, which are produced separately and subsequently connected to one another. The sealing of cavities for the motor or the energy store must be performed with additional seals, for example O-rings. The production of the components and the assembly of the appliance is therefore relatively complex. Furthermore, there are only limited design possibilities, since the process uses a mold core which is pulled after the injection-molding operation, whereby the shaping is restricted to substantially cylindrical geometries. In particular, only razors with straight housing parts can be produced, to permit the components to be pushed in from the rear.

Electric razors with rechargeable energy stores (storage batteries) are known and widely available on the market as dry razors.

The invention is based on the object of providing a possible way of producing razors which meet the requirements mentioned at the beginning and with which maximum freedom of design is obtained, in particular with a minimum number of required tools, in particular for the injection molding, and assembly steps, it being intended in particular for the production of a neck region which is bent and tapered with respect to the handle region to be possible.

This object is achieved by a razor with the features of claim 1 and by a method for producing said razor with the features of claim 17. Advantageous developments emerge from the dependent claims, the description and the drawings.

Preferred embodiments of the invention are specified in the dependent claims, the description and the drawing.

The production of the razor body from at least one hard component and at least one further plastic component, preferably a soft component, permits great freedom of design while at the same time meeting the stability and strength requirements imposed on the razor. The direct encapsulation of at least some of the functional components with the further plastic component, preferably the soft component, that is provided according to the invention results in optimum integration of the functional components in the razor body. This allows the functional components to be positioned at the locations in the body corresponding to the respective design directly from the outside already during the production of the body, so that the designer is given maximum freedom for shaping the razor. For instance, the axes of the handle part and of the neck part can form a significant angle, which can only be realized with difficulty by the known assembly methods. Furthermore, the procedure according to the invention has the effect of making razor production a considerably shorter and simpler process, since injection-molding and assembly steps can be performed simultaneously or in direct succession. Furthermore, it is of advantage that the functional parts are automatically fixed on the razor body by the direct encapsulation with the plastic, which simplifies the carrying out of any further production steps required. In addition, the assembly technology according to the invention means that minimal dimensions are possible in the region of the functional components, which allows handling, weight and production costs to be optimized.

It is also of particular advantage that the functional components can be optimally protected against external influences by the encapsulation, and in particular can be encapsulated in a waterproof manner.

The invention signifies a departure from the known procedure in razor production, in which a strict separation is maintained between injection-molding steps on the one hand and assembly steps on the other hand. According to the invention, it has been found that the functional components can, in principle, be subjected to the pressure and temperature loads occurring during plastics injection molding without the functional capability of the components being impaired.

The preferred embedding of at least some of the functional components in the soft component has the advantage furthermore that the injection-molding operation is less detrimental to the functional components, since the injection pressure of the soft component is less than that of the hard component. The soft component also flows very readily, with the result that the functional components are reliably enclosed even if they happen to be of a complicated shape. A further advantage is that the functional components can be injection-molded in one operation with further soft-elastic elements that are present in any case in most razors, for example soft-elastic elements in the handle region or an elastic zone in the neck region. Consequently, no additional production step is necessary for these soft-elastic elements.

The razor according to the invention has the further advantage that the further plastic component embeds, protects and possibly seals the functional components, but on account of the elastic properties, in particular of the preferred soft component, permits their actuation from the outside and communication or interaction (for example actuation, information transmission, energy transmission) with the outside world.

In a particularly preferred variant of the production method according to the invention, firstly a first, preferably hard, component is produced, in particular injection-molded, without functional components. This first component preferably has a receptacle for the functional components, for example a cross-sectionally U-shaped recess on the rear side of the razor, which can be filled in a simple way before the overmolding. After producing the first component, at least some functional components are positioned and fixed on the first component, the unit made up of the first component and the functional components subsequently being at least partly encapsulated with at least one further, preferably soft, component. In the case of this variant, it is of advantage that no special measures have to be taken for the functional components that are to be encapsulated in order to hold them securely on the injection mold. In particular whenever the first injection-molded component is a hard component and the further injection-molded component is a soft component, this variant offers the further advantage of being particularly undetrimental to the functional components that are to be encapsulated with the soft component, since soft components can, at least in most cases, be injection-molded with low pressure and low temperature in comparison with the hard component.

According to an alternative variant, before a first component is produced, at least some functional components are positioned in an injection mold and then encapsulated with the first component, the unit made up of the first component and the encapsulated functional components subsequently being encapsulated with at least one further component. Since, in the case of this variant, the functional components are firstly positioned on the injection mold, and therefore the mold has to act on the functional parts to hold them, after the first component has been injection-molded it is provided with clearances for the application points on the pre-positioned functional components. When the further component is injection-molded, these clearances are closed, so that they can no longer be seen on the finished product.

To minimize further the loads on the functional components caused by the injection molding, it may be provided according to a further exemplary embodiment of the invention that, at least in the case of one component, a covering of the functional components is firstly formed in a first step at low injection pressure and, subsequently, the component is completed with high injection pressure in at least one further step.

Furthermore, it is provided in a variant of the invention that, before the injection molding of a further component, the unit made up of at least a first component and functional components that are to be encapsulated has fixed on it at least one further functional component to be encapsulated. This further functional component is in particular a contact element, for example in the form of a pin, clamp or clip, for establishing an electrical connection between two or more other functional components.

The functional components can be used in an advantageous way for an intended purpose if, according to a further preferred embodiment of the invention, at least one cavity of a first component, intended for one or more functional components to be inserted later, is sealed with respect to a further component by at least one functional component encapsulated with the first component and/or to be encapsulated with at least one further component.

According to a further preferred exemplary embodiment of the invention, it is provided that, by injection molding preferably a soft component, there is formed an actuating region which can be pressed into a cavity of a previously injection-molded hard component for actuating at least one electrical functional component. As a result, the elastic properties of the preferably soft component are used in an advantageous way to create an actuating region, for example for activating a switching element arranged in the razor body for switching the razor on and off. Preferably, the switching region which can be pressed in is arranged on the same side for the operator as the holding region of an exchangeable blade with a corresponding changing mechanism. The changing mechanism may likewise be triggered by means of pressure on an actuating zone comprising a soft component that is provided for the consumer.

Furthermore, it is proposed according to the invention to produce a vibration-damping region of the body, located in particular in the neck region or in the region of the transition between the neck region and the handle region, from at least two different material components, in particular plastic components. This allows the damping properties of the damping region to be adapted specifically to the respective requirements. In particular, it is preferred if the vibration-damping region is formed by a specific weakening of a hard component by means of a soft component.

For forming the vibration-damping region, it is preferred if the hard component is produced with a pattern of recesses which are subsequently filled by injection molding at least one further component, which is in particular a soft component.

The vibration device is positioned in a preferred way as close as possible to the blades, for example in the neck region. The vibration-damping region is preferably arranged between the vibration device and the handle region, in order to keep the latter as free from vibration as possible.

An electrical connection between a vibration device arranged in the head region or in the neck region on the one hand and an energy store arranged in the handle region on the other hand can preferably be established or interrupted by means of a bistable switching element, which can be changed over between two at least substantially dimensionally stable states by activation of two legs located on opposite sides of an articulation region.

Such a bistable switching element, which is also referred to as a “butterfly”, can be actuated, in particular, by a switching region which is formed by an injection-molded soft component and is pressed by the user into a cavity in which the butterfly is arranged.

The functional elements which are encapsulated directly with at least one plastic component are, in particular
a vibration device, which preferably comprises an arrangement made up of an electric motor and an eccentric or an electromagnetically driven oscillating armature including a protective sleeve,
electrical lines connected to the vibration device,
separate contact elements, which serve for establishing electrical connections between the other functional components.

It is also possible in principle—depending on the respective construction of the razor—for the functional components that are to be encapsulated also to comprise sensors (for example sensors for measuring pressure and time, for positional determination, for determining movement and for the detection of chemical substances or compositions), light-emitting components, resistors, ICs, switching devices and acoustic components. Furthermore, plug-in contacts (sockets), for example for charging the energy source or for current or data transmission, data carriers, for example microchips, or a passive transmitter that can be used for example for protection against theft (Radio Frequency Identification Chip) may be present. In the case of certain applications, for example use of a passive transmitter, it is not necessary to integrate an energy source into the razor.

By overmolding with the further component, the functional components are fixed at the intended site, and, if the soft-elastic component is used, they are, if necessary, flexibly mounted and sealed in the overmolded region against the ingress of water. One possible way of establishing contact with the outside world is to overmold functional components with a thin layer of the soft component which can be perforated to establish a conducting connection. The rubber-elastic soft component has the property of re-closing itself in a waterproof manner after removal of the pointed contact-maker. A similar principle can be used to establish within the razor a conductive connection between components which are movable in relation to one another, for example by bending of the razor.

The functional components may consequently be electronic components, which have a comparatively great sensitivity to external influences. The functional components may be provided with a protective sheathing, for example made of plastic, ceramic or metal. What is more, the functional components may be at least partly encapsulated with a resin or some other protective material.

To reduce to a minimum the loads to which the functional elements that are to be encapsulated are subjected, it is preferred according to the invention if the process uses a relatively low injection pressure, although homogeneous material distribution in the respective injection-molded part is ensured at the same time. Plastics which flow particularly easily are preferably used. The material which is preferred according to the invention is polypropylene (PP) with a melt flow index of MVR 4-25, use being made in particular of PP with a melt flow index of MVR 20.

Furthermore, relatively low processing temperatures are preferably provided according to the invention. In particular when, according to the particularly preferred variant mentioned above, firstly a first component is injection molded without functional elements, a thermoplastic elastomer (TPE) is used as the preferred material for encapsulating the functional components, to be precise at a temperature in the range of 170° C. to 250° C., preferably of approximately 200° C.

According to the invention, when injection molding the component it is possible in each case to use either a single injection point or a plurality of injection points. In the case of a single injection point, its position is preferably chosen in such a way that the most sensitive functional component is located at the greatest possible distance from the injection point, with the result that it is necessary to cover the longest possible plastic-filling distance to this functional component. If use is made both of a single injection point and of a plurality of injection points, it is also possible to work in each case with an injection pressure which varies over time. The pressure profile may in this case be adapted specifically to the respective conditions. In particular at the injection point located nearest to the most sensitive functional elements, it is possible to work with a relatively low holding pressure of less than 600 bar, preferably of less than 200 bar.

As far as the plastic materials used are concerned, acrylonitrile-butadiene-styrene (ABS), polystyrene (PS), polyethylene terephthalate (PET), styrene-acrylonitrile (SAN), polycarbonate (PC), polyamide (PA) or polymethyl methacrylate (PMMA) may be used for example for a hard component of the razor body, the preferred material being polypropylene (PP). For the soft component, a thermoplastic elastomer (TE) which has an affinity with the respective hard component, i.e. bonds with the hard component, is preferably used, whereby particularly suitable soft-elastic or rubber-elastic properties can be achieved.

A transparent, or at least translucent, plastic may be provided for at least one component of the razor body. MABS, SAN, PA, PC, PMMA, PS or PET, in particular, come into consideration for this. During the processing of transparent plastics, use is preferably made of a comparatively high injection pressure, for which purpose the aforementioned variant in which firstly a first component is injection molded without functional elements is particularly suitable.

In order not to subject the functional components to inadmissibly large forces, for example flexural or torsional forces, it is further provided according to the invention that in such regions of the razor body in which functional components are arranged the wall thickness of the plastic does not go below a predetermined minimum. In the case of the hard component, this minimum wall thickness preferably does not go below a value of approximately 0.5 mm, the minimum wall thickness preferably being in the range of 1 to 5 mm. A region at which the wall thickness goes down to the minimum value is preferably the region of the neck at which the vibration device is arranged.

The minimum layer thickness of the soft component that is to be overmolded is 0.5 mm. Preferably, however, this lies between 1 and 6 mm, in order that the functional components cannot show through in the case of light colors of the soft component, and in order that there is a kind of damper against the sometimes hard (for example metallic) functional elements during shaving.

According to a further preferred embodiment of the invention, it is provided that at least some functional components are arranged on an already injection-molded plastic component, in particular a hard component, in such a way that, in relation to the direction of flow of a further plastic component that is still to be injection-molded, in particular a soft component, at least certain regions of the functional components are located in the shadow of at least one protective portion of the hard component.

This allows the functional components that are to be encapsulated to be protected in a particularly simple and nevertheless effective way from the influences of the component or components subsequently to be injection molded, in particular with regard to pressure and temperature. The portions located upstream of the functional components are, in particular, obstacles or projections of the previously injection-molded component that are specifically provided or present in any case as part of the construction.

Furthermore, the plastic body to be injection molded for the razor according to the invention is preferably designed in such a way that sharp projections, corners and edges are avoided in the region of the functional components, in order to eliminate, or at least reduce to a minimum, the risk of fracture caused in particular by a notching effect.

To supply functional components with electrical energy, use is preferably made of flexible electrical lines in the form of a metal wire, which are preferably provided with an electrically insulating sheathing, at least whenever lines of different polarities are routed together. It is possible to dispense with such a sheathing, in particular whenever the lines concerned are routed separately and at a sufficiently great distance from one another. Alternatively, the electrical connections may be provided in the form of injection-molded, electrically conductive plastics, punched metal plates, conductor tracks embossed metallically on the injection-molded plastic component, or conductor tracks applied to the injection-molded plastic component by electroplating methods.

Furthermore, preferably at least those electrical connections which are routed along those regions of the razor that are subjected to elastic deformations, such as in particular the neck region, are configured in such a way that on the one hand they are as flexible as possible and fracture-resistant with respect to alternating bending and on the other hand they do not lead to additional stiffening of the region of the razor concerned.

The plastic body of the razor is preferably formed according to the invention in such a way that electrical connections between a power source and a power-consuming unit run along a substantially straight line. As a result, electrical lines can be drawn during assembly in a particularly simple way. For this purpose, an at least substantially straight channel for electrical connecting lines is preferably formed in one of the injection-molded components of the razor body. Holding aids for fixing the electrical lines before the encapsulation are preferably provided by means of the hard component or further functional components.

In a further variant of the invention, the direct charging technique known per se for razors is adapted in such a way that it can also be used in the case of wet razors with electrical functional components. The charging current is transferred directly, i.e. by means of contact elements, to the electric razor by means of a power supply unit—comprising a transformer and a rectifier element or comprising a clocked electronic circuit. Within the razor there is a contact element, if appropriate with connecting lines to the storage battery. There is more freedom of design to meet esthetic requirements. The invention permits the use of favorable, mass-produced components, possibly the use of standardized elements, and consequently the use of power supply units that are already present in a household.

According to the invention, a cavity of the razor in which the energy store is located is sealed by a sealing element, with the result that, when the razor is used in the way intended, no ingress of water or other foreign matter is possible. Corrosion and contamination of the energy store and of the electrical contacts are prevented in this way.

In a variant of the invention, the energy store and the contact element are located together in the cavity, which is sealed during use in the way intended, i.e. during shaving. The sealing element used for this purpose can be moved at least to the extent that the contact element is accessible for the charging operation.

In an advantageous development, the charging logic is designed in such a way that it is not possible for the appliance to be operated during charging. As a result, short-circuits and contamination of the interior space are prevented and the safety of the user is increased.

The razor is preferably packed in such a way that the presentation in the pack is self-explanatory. For example, the power supply unit and/or the contact elements are visible through viewing windows. In this way, the purchaser can also check whether he already has a suitable power supply unit. The handle region with switching membranes is preferably presented to the front, so that the user can test the appliance through the pack by pressing on the membrane.

The storage battery is preferably of the NiCd (nickel cadmium) or NiMh (nickel metal hydride) type. Mass-produced cells of the AA or AAA type are used. The appliances are preferably operated with a voltage of below 4 volts, preferably with 1.2 volts. For reasons of cost, a single 1.2-volt storage battery cell should be used. An optimum period of use per discharging cycle of the storage battery is at least 2 h, but preferably at least 5 h or more. If this ratio can be achieved with an AAA cell, this size is preferred for reasons of space. In the case of a razor with a vibrating head part, the preferred capacity of the AAA cell is 300-800 mAh.

Since the storage battery can produce explosive gases during the charging operation, such as oxygen and/or hydrogen, the cavity is preferably sealed with a sealing element which is gas-permeable but protects the cavity from water. A corresponding membrane attached to the hard component is preferably used.

The power supply unit used is connected to the local power supply (for example 230V AC or 115V AC). The power supply unit is preferably formed in such a way that the power plug is integrated in the housing and the power supply unit can consequently be inserted directly into a power receptacle. In this case, a power supply unit of protection class II, 4 kvolts and IF X4 is used (standard IEC 60529, DIN 40050). It is less preferred, but also possible, for a power cable to be provided between the power receptacle and the power supply unit; in the case of this design variant, a power supply unit with a higher class of protection, for example IP X7, would have to be used. The power supply unit is in any event to be kept short-circuit-proof.

In the power supply unit, the local AC supply voltage (for example 210-250 volts AC 50 Hertz) is converted into a low-volt AC voltage, in order in this way to charge the storage battery. The DC voltage (4-7 volts DC) is then transferred by means of a cable and contact elements directly from the power supply unit to the electric razor. The charging currents are preferably at 30-230 mA, corresponding to 10% of the storage battery capacity (C/10). This leads to a charging time of 10-14 hours in the case of the types of storage battery mentioned above. The cable serves for bridging the distance between the nearest connection to the power supply and a place where the electric razor can be put down. This length of cable is between 0.5 m and 2 m, preferably 1.5 m. In a less preferred variant, the electric razor is inserted directly into the power supply unit with corresponding contact elements.

Contact elements of the plug-and-socket type are preferably used. The plug is preferably attached to the cable of the power supply unit. For safety reasons, a plug which is hollow inside and respectively provides a phase on the outside and a phase on the inside of the plug is used. This construction avoids short-circuits when the plug is placed on an electrically conducting surface. The contacting element of the plug has approximately the following dimensions (length 3-15 mm, preferably 10 mm/diameter 2-10 am, preferably 5.5 mm).

The contact element formed as a socket is preferably provided in the electric razor. The socket preferably has the possibility (for example by means of a pin) of being contacted not only by the plug but also by other electrically conducting components (for example in the cover). For this reason, this pin should have a minimum diameter of 1-4 mm, preferably 2.4 mm. The pin is preferably connected to the (+) terminal of the motor and of the storage battery. Preferably interacting with the contact element is a switch, which during the charging operation decouples the consuming unit and charges only the storage battery.

In order to keep the costs low, the plug-in contacts are preferably mass-produced parts. The metallic surfaces of the contact elements are generally surface-coated (for example gold, nickel, chromium, etc.). A nickel layer on the one hand guarantees good electrical conductivity and particularly good corrosion resistance against the aggressive mixture of shaving foam and water with at the same time low prime costs. The socket is generally chosen to be the same size as or smaller in size than the diameter of the storage battery, with the result that the dimensions of the interior space can be minimized. (Outer dimensions: width/height of the socket when using a storage battery of the AAA size, preferably less than 10.5 mm, length dependent on the plugging-in distance chosen, storage batteries of the AA size, less than 14.5 mm).

The plugging-in operation is preferably performed with a clear movement (translation, rotation or a combination of these) of 1-10 mm and/or 10-180°, preferably of the plug with respect to the socket. In the case of contamination and corrosion, this allows a certain amount of rubbing of the contact surfaces, which has a self-cleaning effect and in this way facilitates the contacting. During the plugging-in operation, a certain pressure is to be produced between the surfaces to be contacted (for example by means of spring action of one contacting surface on the other), in order that contamination can likewise be effectively scraped away. The plugging-in operation is consequently preferably performed by means of a combination of movement and pressure of the contacting surfaces against one another. At the end of the plugging-in distance, the plug is intended to latch in the socket, with the result that independent release of the plug or loose contacts between the plug and the socket are prevented. The force necessary for releasing the plug is preferably greater than the dead weight of the complete electric razor in the pulling direction of the plug. The socket preferably undergoes form-fitting latching with its carrier unit, for example the printed circuit board, in order that the plug-in forces do not rest on the, for example soldered, electrical contacts.

Since certain forces are exerted in the above-defined plugging-in operation, it must be ensured that fragile components of the electric razor are not damaged. In particular, it must be ensured that the user does not cut himself on the blades or that vibration-damping means in the neck region are not deformed by the forces produced. For this reason, the contact elements are to be positioned on or in the handle in such a way that the handle still has sufficient space available for it to be comfortably held in the other hand. In this respect, it is desirable for the contact elements to be positioned at one or the other end of the handle. In addition, the holding points in the handle region at which the electric razor should be held during the plugging-in operation are to be marked for the user. Geometrical elements (such as indents, protuberances, surface textures, etc.), and/or zones with soft materials and/or a corresponding imprint may be used for this purpose.

The plugging-in direction is proposed as being at an angle between −90° and 90° in relation to the longitudinal axis of the handle part, although, as mentioned above, the plugging-in operation preferably takes place in the direction of this main axis in order that the plugging-forces can best be absorbed by the other hand.

The plugging-in operation can be simplified by the contact elements having a rotationally symmetrical, preferably circular, cross section. The relative position of the plug-in contacts is consequently not important and need not he sought by the user. It is only the plugging-in direction that has to be correct. In the design variant shown, the plugging-in direction is preferably provided parallel to the opening direction of the closure.

The position of the contact elements with respect to the electric razor is decisive with respect to the contamination tendency, sealing of the interior space, plugging-in operation during charging and comfort during use of the electric razor. The electric razor is preferably provided with geometrical elements, preferably formed from soft components, on the outer casing, in order that the setting-down position after use is clearly defined for the user. In addition to one or, if need be, more defined horizontal setting-down positions, this is to include a flattened handle part, in the case of which the electric razor assumes a more or less vertical position.

The contact elements are preferably provided in the interior or in an outer layer of the electric razor and sealed with a sealing element, for example a protective layer of plastic comprising a soft or hard component or a combination of these. In the case of this design variant, the surface of the handle part may be entirely covered with plastics, so that no pressure points on the surface of the hand can occur during shaving. The contact elements are likewise better protected against contamination.

The contact elements are placed in the actual cavity of the electric razor at a place which is easily accessible for the user, preferably in the direct vicinity of the separating line between the handle part and the closure. The entire cavity, including the contact element, is closed in a sealing manner by a sealing element, for example a closure. The sealing element may be produced in one operation with the electric razor from the same hard component and soft component, possibly only from the soft component. A permanent connection between the sealing element and the razor handle is optionally provided, for example in the form of a film hinge. The contact elements are fixed on a solid carrier unit made of plastic or on a printed circuit board and are electrically connected to the storage batteries (for example by means of conductor tracks or cables, etc.). This solid carrier unit may also include further functional units, such as switches, a drive and a storage battery, etc. It preferably comprises a printed circuit board with the contact elements firmly connected to it, the storage battery and further components of the circuit, for example conductor tracks or a resistor. This so-called storage-battery subassembly is a self-contained system which has the outer appearance of a rechargeable battery with integrated plug-in contacts. This subassembly can be used like a conventional disposable battery. The terminals of the energy store are accessible from the outside directly or via the contact element.

To optimize the manageability of the electric razor, it is proposed to place the contact elements in series with the storage battery (i.e. one behind the other) on the carrier unit. The diameter of the interior space consequently corresponds approximately to the size of the storage battery plus the carrier unit. In the design variants in which a storage battery of the AAA size is used, the diameter of the AAA battery and the thickness of the carrier unit with the printed circuit board and the storage battery correspond approximately to the diameter of an AA battery. The minimal storage-battery subassembly described above can consequently be replaced with little outlay by an AA battery. It is consequently possible with few changes (bridging the difference in length) to operate the electric razor with a disposable AA battery. Furthermore, the same injection molds can be used for producing a rechargeable electric razor and a razor with a disposable energy store.

There is no risk of the contact elements being contaminated, since the interior space is only open for charging the storage battery. However, it must be ensured that the appliance cannot be used when the cavity is open, for example during the charging operation, since the cavity does not have a seal in this state. In the case of this design variant, the other technical components (such as the drive, storage battery, etc.) are preferably covered by means of a not necessarily waterproof shield (for example with a fitted plastic part or a self-adhesive plastic label). The shield allows protection during the charging operation against splash water in the wet cell and clearly shows the user the contact elements which are not covered by it. Other technical units which could confuse the user are not visible.

The accumulator subassembly in the minimal form required comprises a storage battery, a resistor and a carrier unit, for example in the form of a printed circuit board. If the contact element is not molded into the body (closure, handle part), the contact element is preferably also a component part of the storage-battery subassembly, which can consequently replace one or more disposable batteries. If necessary, this subassembly may be supplemented with further components, for example with switching elements, a timer function, a motor or an LED. The resistor used prevents overcharging of the storage batteries and allows a constant charging current from the power supply unit. When a preferred power supply unit with an output power of 7 volts DC without load and 4 volts DC with load at 230 mA is used, the following resistance values are obtained by way of example for different cell capacities, depending on the design variant:

| Cell capacity | Charging current | |
|---|---|---|
| (mAh) | (mA) | Resistance (ohms) |
| 600 | 60 | 120 |
| 1500 | 150 | 47 |
| 2300 | 230 | 22 |

The resistance is preferably chosen to be somewhat higher than necessary, in order that ‘other’ power supply units with a higher charging current can also be used without the storage battery being damaged.

The charging logic is an essential component part of the overall charging technique. The design according to the invention allows satisfactory charging of the storage battery and differentiated limiting of the operation of the electric razor during different operating states in dependence on the sealing of the interior space. This is described below with reference to [lacuna].

In a further advantageous variant, a holding device is provided for the wet razor, for example in the form of a stand. The razor inserted in it is positioned in such a way that the contact elements are not positioned in the direction of flow of the water or at the dripping-off points. It is intended for the charging operation also to be possible when the user does not have the holding device with him. The holding device is either purely mechanical, serves only as a supporting and positioning aid for the electric razor and does not contain any electrical components. In the case of this design variant, it must be ensured that the contact elements are freely accessible if the electric razor is placed on the holding device. In another variant, the holding device includes additional electrical elements, for example a timer unit, a charging-state display, a charging-capacity display or music. These additional electrical elements are powered by the same contact elements as the electric razor itself, i.e. they preferably function at the same operating voltage as the razor. The holding device is only an ‘intermediate electrical element’, which may or may not be used. When traveling, the razor can in the case of this design variant likewise be charged directly by the power supply unit. Consequently, the holding device has the same plug-in contacts as the power supply unit and the electric razor. A sales unit contains the electric razor including the power supply, possibly with additional exchangeable blades/and optionally the holding device, depending on the design variant. The power supply unit including elements for the power supply connection and the contact elements used for the connection to the electric razor are preferably displayed in a see-through pack, in order to show the user that the razor is a rechargeable one. As an additional option, a cover may also be presented in the open state, with the result that the user sees immediately how the electric razor can be recharged.

The invention is described below by way of example with reference to the drawing, in which:

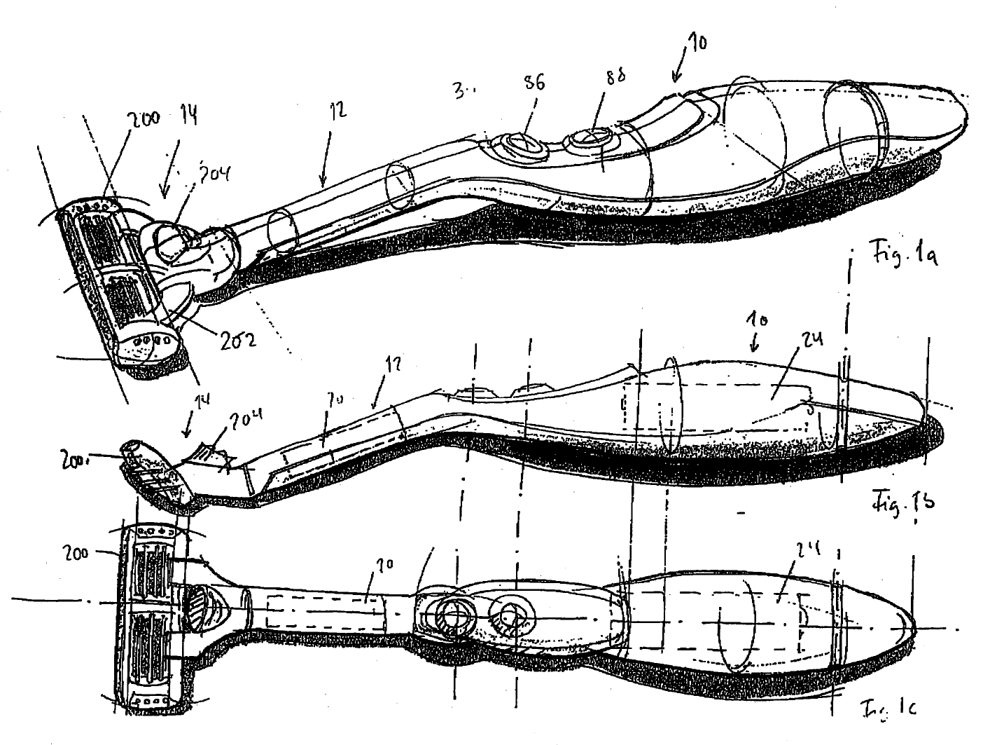

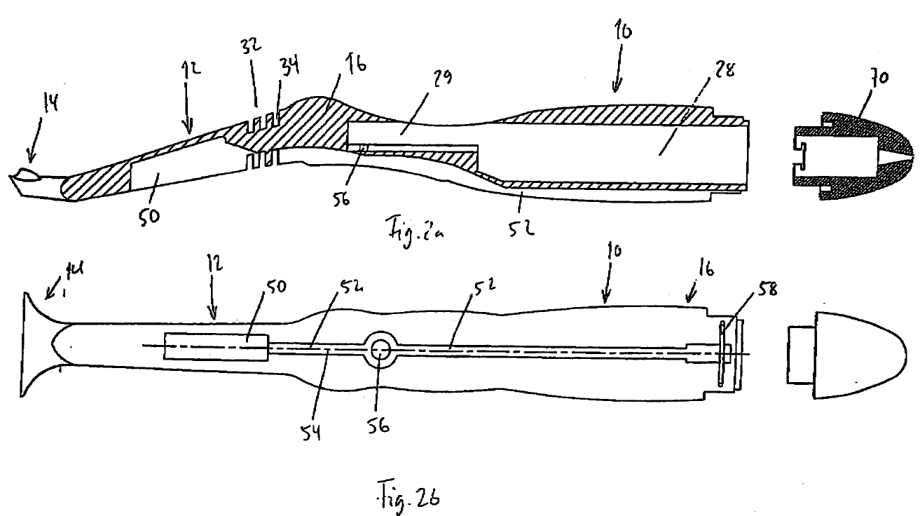

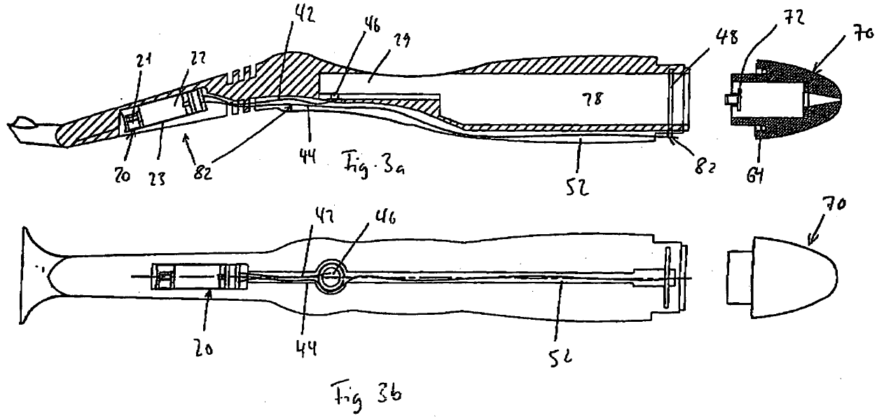

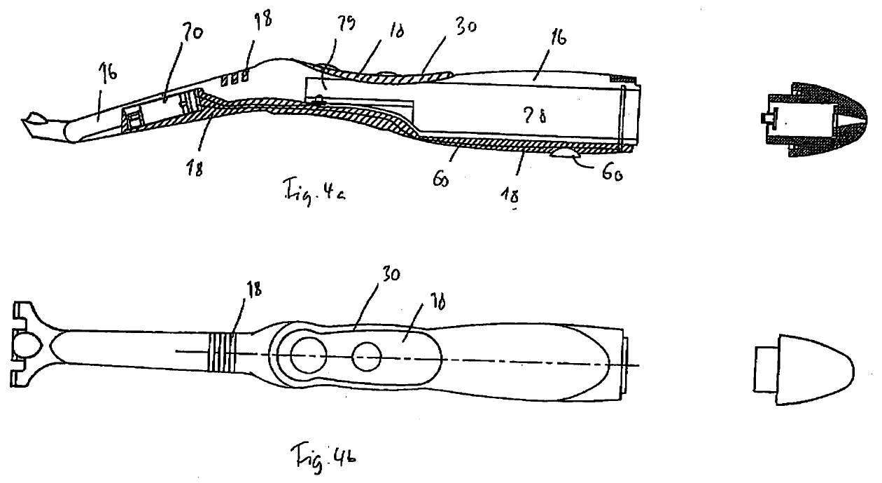

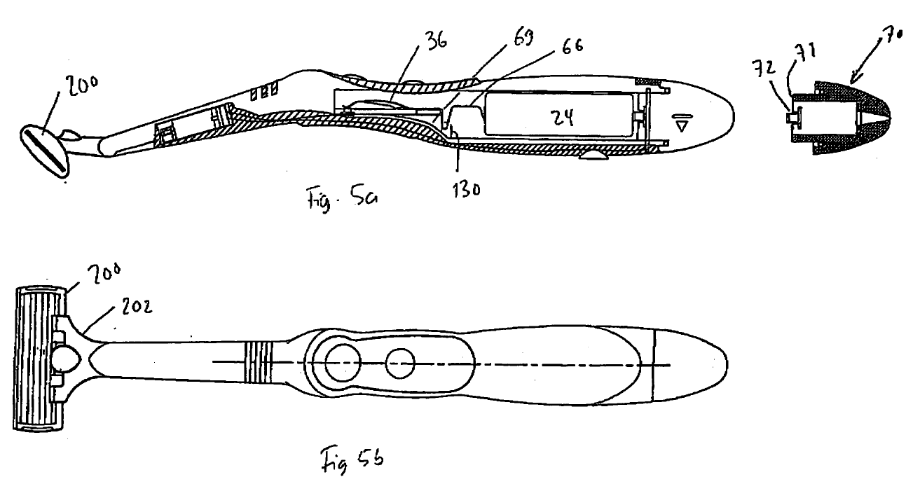

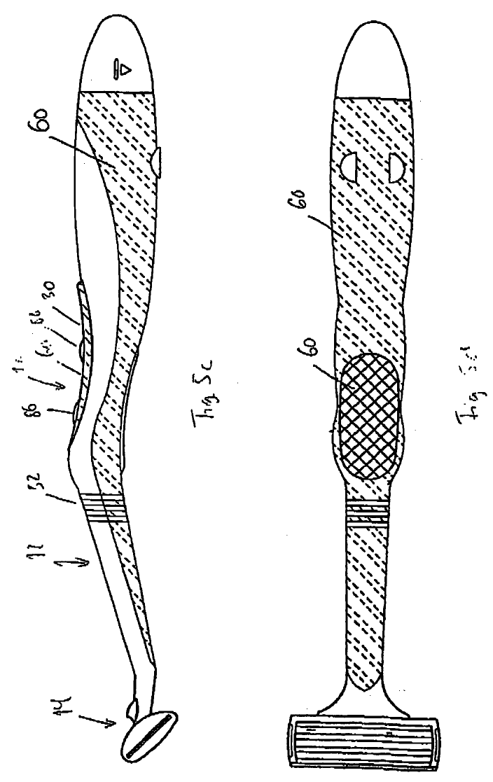

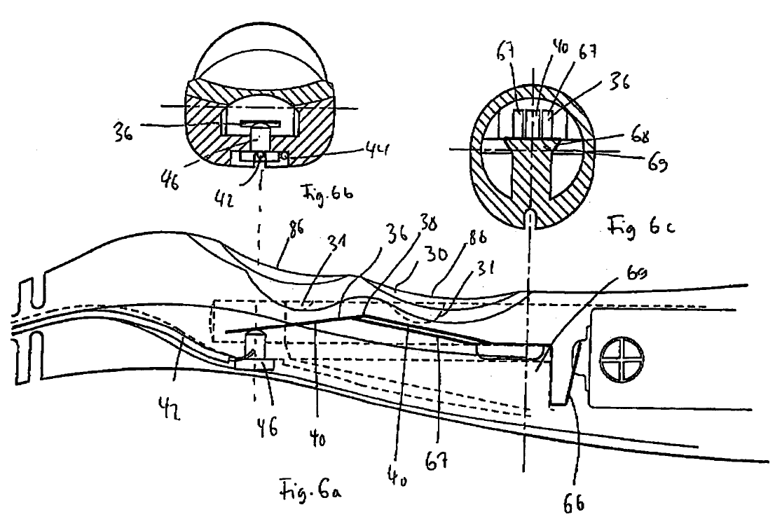

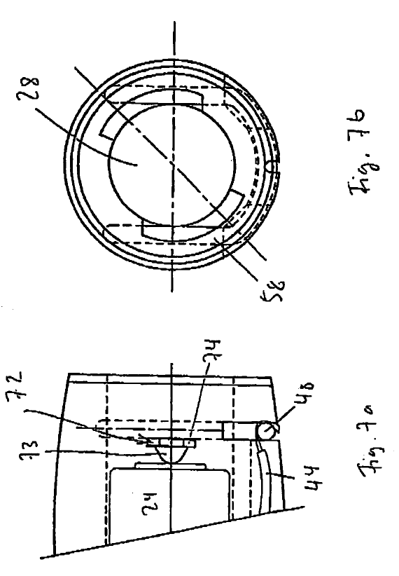

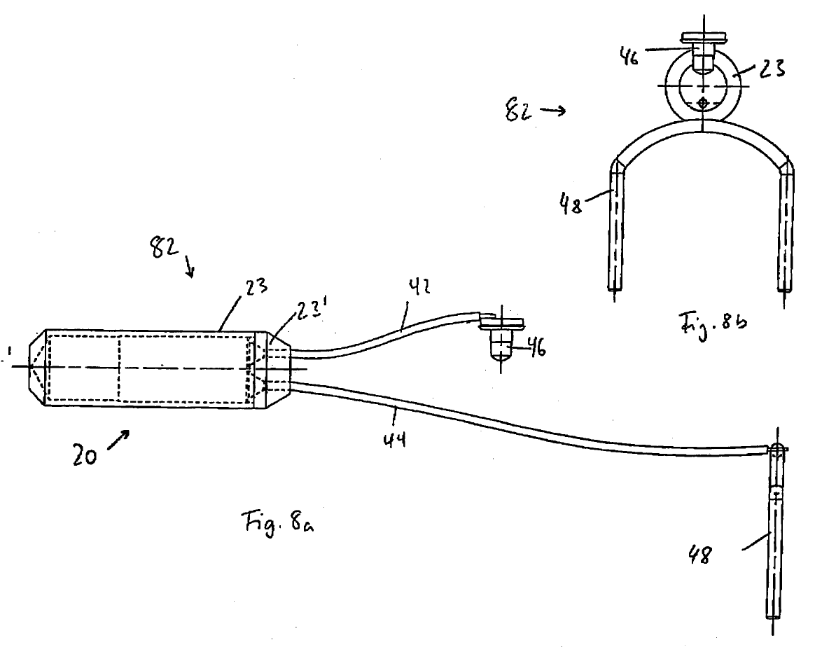

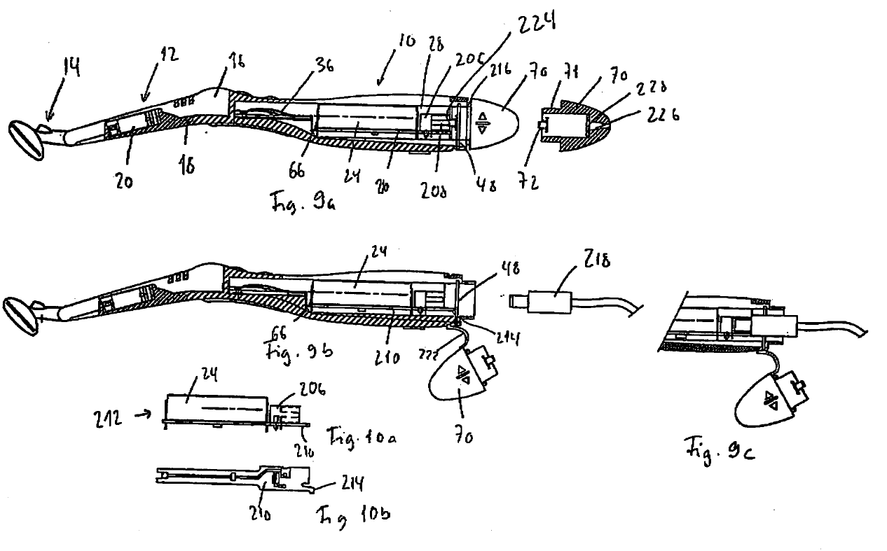

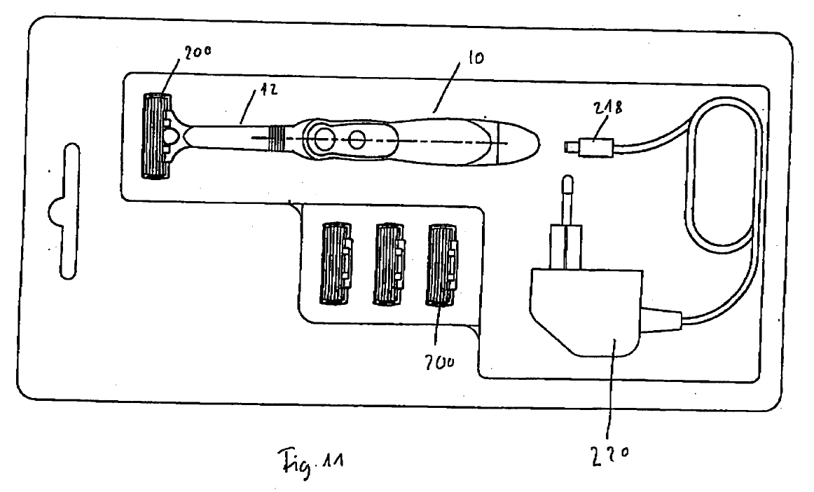

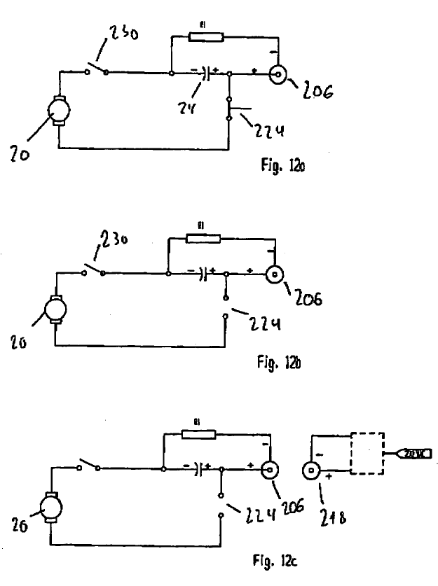

FIGS. 1a-c show various perspective views of a razor;

FIGS. 2a,b to FIGS. 5a-d show a razor in various stages of its production and various views;

FIGS. 6a-c show an enlarged representation of the arrangement and mode of operation of the switching element of a razor;

FIGS. 7a,b show an enlarged representation of the rear end of the handle region;

FIGS. 8a,b show a motor subassembly before being attached to the hard component;

FIGS. 9a-c show a razor with a rechargeable energy store;

FIGS. 10a,b show a storage-battery subassembly for the replacement of a disposable battery;

FIG. 11 shows a sales set, comprising a razor, exchangeable blades and a power supply unit;

FIGS. 12a-c show circuit diagrams of the charging circuit;

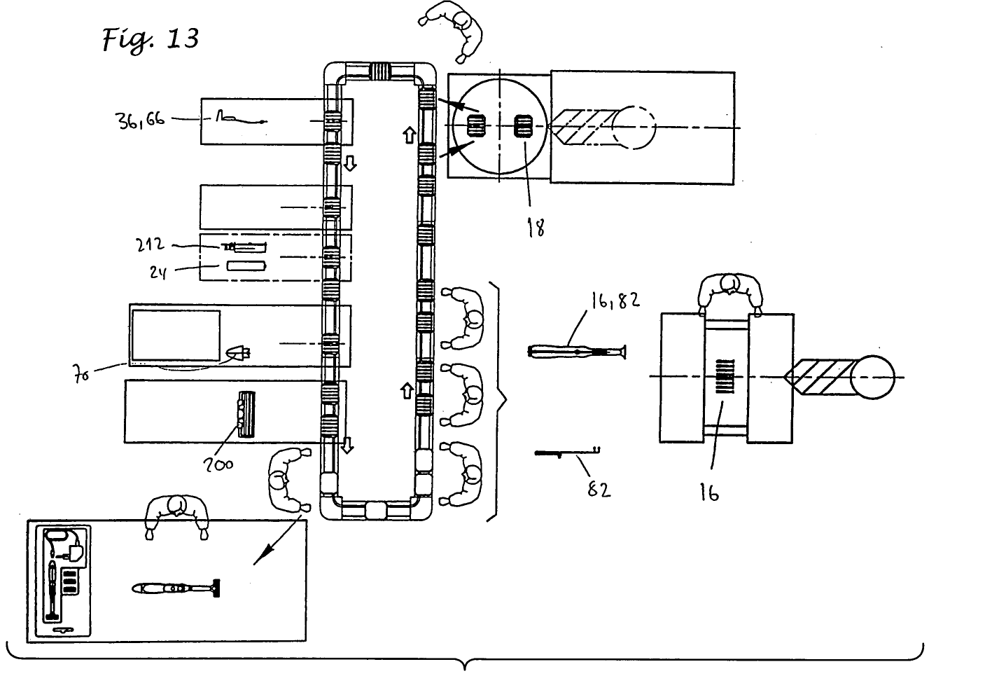

FIG. 13 shows a basic diagram of the production method;

FIGS. 14a-c show various views of a further wet razor;

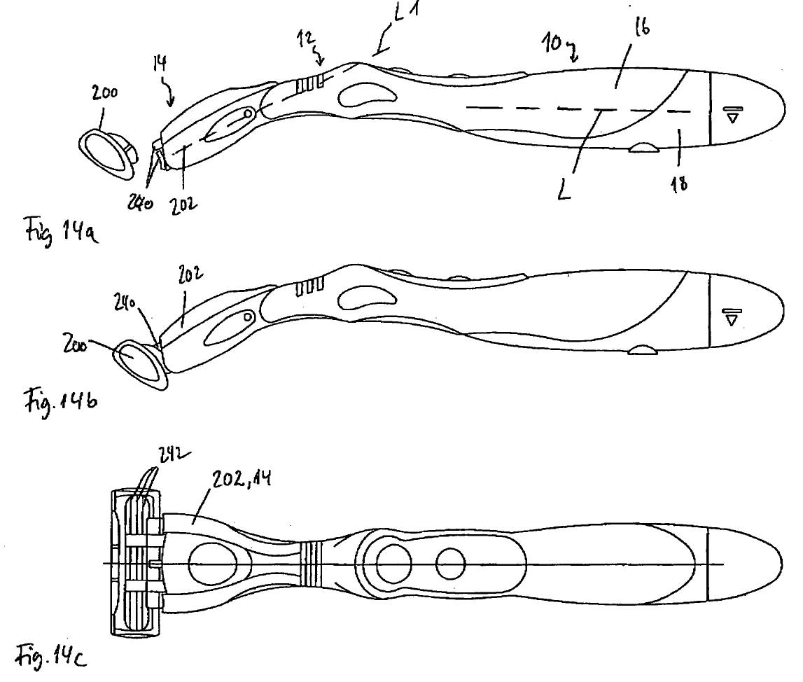

FIGS. 15-17 show longitudinal sections of wet razors with a flat-frame motor as a vibration device;

FIG. 18 shows various views of a razor with an additional decorative element in the handle region.

FIGS. 1a-c show a razor according to the invention in a perspective representation obliquely from the side (FIG. 1a), from the side (FIG. 1b) and from above (FIG. 1c). The razor body comprises a head region 14 with an exchangeable blade element 200, which is held on the body by means of a holding device 202 with a changing mechanism to be actuated by an actuating element 204. As indicated in FIGS. 1b and 1c and represented in more detail in FIGS. 2-5, in the neck region there is an electrically operated functional unit in the form of a vibration device, in particular a motor with an eccentric. In the handle region 10 there can be seen a switching region 30 with two switching points 86, 88, which serves for switching the functional unit 20 on and off. In the interior of the handle region 10 there is an energy store 24, which is likewise only indicated here. FIG. 1b in particular shows the neck region 12, which is clearly angled away from the handle region 10. The ergonomically shaped handle region 10 can likewise be seen.

The variant initially described below on the basis of FIGS. 2 to 5 relates to a preferred production method according to the invention, in which firstly a hard plastic component 16 of the razor body is injection-molded without functional components.

FIGS. 2a,b show the finished injection-molded hard component 16, in which a handle region 10, a neck region 12 and a head region 14 without an exchangeable blade 200 are already formed. Furthermore, a cover 70 is separately produced. This can be fitted in place on the handle region 10, in order to close a cavity 28 in the handle region 10 serving for receiving an energy store in the form of a disposable battery or a rechargeable storage battery of the AA or AAA type. The head region serves for receiving a holding device, not discussed any further here, for the exchangeable blades 200. They can be actuated as and when required in order to exchange blades. The exchangeable blades 200 preferably have vibration-damping elements comprising a soft component, in order that the vibrations act in particular on the blades. For the same reason, the blade 200 is resiliently mounted with respect to the handle region 10.

The neck region 12, keeping the head region 14 and the handle region 10 at a distance, preferably has a length in the range of 10 mm to 40 mm, and in particular of approximately 30 mm. The neck region 12 connecting the handle region 10 and the head region 14 to one another is at least partly tapered, and preferably angled away somewhat, with respect to the handle region 10 and the head region 14, as can be seen from FIG. 2a, showing the side view. The angle of the neck region 12 (defined by the axis of the motor) with respect to the handle region (defined by the axis of the battery) is between 10° and 60°, preferably approximately 30°. The angle between the neck region and the head region is likewise approximately 10°-60°, preferably likewise approximately 30°. The handle region with the cover has a length of 80-160 mm, preferably approximately 130 mm. The head region has a length of 5-20 mm, preferably approximately 10 mm.

The hard component 16 further comprises a recess 50, formed in a cross-sectionally U-shaped manner in the neck region 12, for a vibration device. Formed in the transitional region between the neck region 12 and the handle region 10 are recesses 34, which constitute component parts of a vibration-damping region 32 (not represented in the view from below of FIG. 2b). Furthermore, there is a channel 52 for electrical connecting lines, which extends on the underside of the razor from the front cavity 50 into the region of the rear end and is open on the longitudinal side, and also a cavity 29 for the actuation of a switching element (not represented). The last-mentioned cavity 29 is connected via an aperture 56 to the channel 52, which is widened in this region, and also to the cavity 28 serving for receiving the battery.

The hard component 16 also has in the region of the rear end a recess 58 for a U-shaped contact clip.

The aforementioned features of the hard component 16 and the functional components of the razor according to the invention are discussed in more detail elsewhere.

According to FIGS. 3a,b, in a next step a functional subassembly 82, previously assembled from individual components, is fixed on the hard component 16. This subassembly 82 comprises a vibration device 20 with an electric motor 22 and an eccentric 21, which can be driven by the latter and has a length of 1.5-5 mm and a maximum diameter of 4-10 mm, which are arranged in a protective element, here a protective sleeve 23. With this vibration device 20, the head region 14 of the razor can be made to vibrate at a frequency of 10-1000 Hz, preferably 200-500 Hz. The amplitude of the head region may be up to 2 mm, preferably 0.3-0.8 mm. To increase the amplitude, metal parts may be fixed to the basic body and at least partly encapsulated with the soft component by the same production method. Such metal components are preferably to be provided in the neck or head region between the vibration device 20 and the holding device for the exchangeable blades. The construction of the appliance is to be provided in such a way that the deflection of the exchangeable blade is not of equal magnitude in all three dimensions. Preferably, the greatest deflection is to be provided parallel to the cutting direction (i.e. deflection up and down instead of lateral deflection).

The sleeve 23 serves on the one hand for protecting the vibration device 20 from effects of pressure and temperature of the plastic component subsequently to be injection molded and on the other hand for keeping the eccentric 21 free from the plastics material of this component. The sleeve 23, which is resistant to injection pressure, is produced from plastic, ceramic or, preferably, metal, in particular from a nickel-plated brass alloy. Alternatively, the protective sleeve 23 may be formed from a plastic of which the melting point is above the temperature of the plastic component subsequently to be injection molded. Reinforced plastics, for example plastics reinforced with glass fibers, are preferably used. The outer length of the sleeve 23 is approximately 10 to 25 mm, preferably 21 mm, while the diameter of the sleeve 23 is approximately 2 to 10 mm, preferably 7 mm, and the wall thickness of the sleeve 23, which may be up to 3 mm, is preferably 0.5 mm. A cover that is optionally provided in addition extends the length of the protective element (sleeve and cover) by 1-4 mm, preferably 3.5 mm. If a cover is present, filling with a protective layer (for example with resin) is not necessary. Once the eccentric 21 and the motor 22 have been introduced, the sleeve 23 is either closed by means of a cover, which is provided with apertures for supplying power to the motor, or filled with a substance which is applied in a liquid state and subsequently cures (for example a resin, lacquer or two-component glue). A stop is preferably provided on the sleeve 23, level with the end of the motor 22, as a result of which the eccentric 21 is prevented from advancing too far during assembly. The free rotation of the eccentric 21 is consequently ensured.

Instead of a sleeve, two dish-shaped plastic parts which assume the function of the sleeve and cover may also be used. With this embodiment, assembly can be simplified. The vibration device is fixed in the recess 50 of the hard component by means of static friction or a slight press fit. This fixing is to be designed in such a way that this functional element cannot be washed away from the intended place by the soft component that is subsequently injected.

Two electrical connecting lines 42, 44 are connected to the vibration device 20. These connecting lines are preferably provided in the form of a sheathed stranded or single wire made of copper, the wire diameter, which may be up to 1 mm, preferably being 0.3 mm. The thickness of the sheathing lies in the range of 0.1 to 0.5 mm and is preferably 0.2 mm. As a result, the sheathing is reliably protected against being washed away, so to speak, during the encapsulation with the plastic, with the result that no short-circuit can occur even when the electrical lines 42, 44 are displaced on account of the injection pressure.

An electrical line 42 is made to be relatively short and extends as far as the aperture 56 between the widened region of the channel 52 and the central cavity 29. For this purpose, the short line 42 is provided in this exemplary embodiment with a pin-like contact element, the contact pin 46, which is formed as an axial extension of the line 42. The contact pin 46 is produced from metal, preferably from a nickel-plated brass alloy. By means of a switching element which is described in more detail elsewhere, it is possible for the contact pin 42 to be connected to a terminal of an energy store to be arranged in the rear cavity 28. The contact pin 46 is preferably firmly connected (for example soldered) to the short cable 42 and is consequently part of the motor subassembly 82.

Serving for contacting with the other terminal of the energy store is the longer connecting line 44, which extends as far as the recess 58 formed in the rear region and is routed in the channel 52 outside the rear cavity 28. In the region of the recess 58, the connecting line 44 contacts a contact clip 48. With the cover 70 fitted in place, the latter contacts the corresponding terminal of the energy store via a contact portion 72.

As component parts of the prefabricated subassembly 82, the electrical lines 42, 44 have preferably already been made to the required length in each case. Furthermore, the free ends of the lines 42, 44 may already have been stripped and tin-plated, which is of advantage in particular whenever force-fitting connections are provided rather than soldered connections for contacting with further electrical functional components.

The functional unit has preferably already been assembled with the soft component before insertion into the razor body and before encapsulation. For example, the contact pin 46 and the U-shaped contact clip 48 have already been firmly connected, in particular soldered, to the cable ends. This rules out production uncertainties.

To fix the lines 42, 44 on the hard component 16, the channel 52 between the vibration-damping region 32 and the widened channel region is formed with fixing elements for the electrical connections (not represented). This holding region 54, formed for example as a labyrinth, has the effect that the lines 42, 44 are secured against falling out and against tension. Alternatively, channel constrictions, undercuts or separate elements made of metal or plastic may be used for the fixing. Alternatively, the electrical components may be thermally and/or mechanically fused with the hard component and thereby fixed.

The contact pin 46 and the aperture 56 are made to match one another in such a way that the cavity 29 located in the central region is sealed from below against the penetration of plastic of the component subsequently to be injection molded.

Before the injection molding of the next, preferably soft, component, the already mentioned, U-shaped contact clip is introduced, in particular pressed in a force-fitting manner, into the recess 58 formed at the rear end, whereby the long connecting line 44 is also fixed at its free end. The contact clip is produced from metal, preferably from a nickel-plated brass alloy.

FIGS. 4a, b show the razor according to the invention after the injection molding of the next component, here a soft component 18, in section and from above, respectively. The injection molding of the soft component 18 takes place in a second cavity (mold cavity) of the injection mold, into which the hard component 16 is placed once it has been fitted with the functional components described above (vibration device 20 made up of the sleeve 23, eccentric 21, possibly the sleeve cover and motor 22, electrical lines 42, 44, contact pin 46 and contact clip 48).

The soft component 18 covers over these functional components arranged on the hard component 16, i.e. these functional components are encapsulated directly by the plastic forming the soft component 18.

The cavity 29 provided in the central region is closed in the upward direction by the injection molding of the soft component 18. The soft-elastic plastic of the soft component 18 forms here a switching region 30, which can be pressed into the cavity 29 by actuation from the outside and is provided on its outer side with two switching points 86, 88, corresponding to which on the inner side are two switching projections 31, protruding into the cavity 29 (see FIG. 6a). The forming of this switching region 30, also referred to as a switching membrane, takes place with the aid of a mold core (not represented) of the injection mold, said mold core being introduced into the cavity 29 during the injection molding of the soft component 18. The soft-elastic properties of the switching region 30 permit unproblematical forced demolding by the mold core being withdrawn to the rear, whereby the compliant switching region 30 is pressed outward via the switching projections 31 and, on account of its elasticity, subsequently resumes the normal position shown in FIG. 3.

The Shore hardness A of the soft component preferably lies below 70, preferably below 40, and is in particular approximately 35. In this range, the soft component has the optimum properties for the function of the damping elements and sealing elements and also for the switching region for the actuation of the switch.

Furthermore, the vibration-damping region 32 is completed by the injection molding of the soft component 18, in that the corresponding recesses 34 of the hard component 16 are filled with the plastic of the soft component 18.

As indicated in FIGS. 4a, b and FIGS. 5c, d, it is possible for the injection molding of the soft component 18 also to form further functional regions 60, which are preferably designed as additional damping regions in the region of the finger rest and/or hand rest or as supporting elevations, and may be provided for example in the form of ribs, small pads or repeating patterns of basically any desired configuration.

Furthermore, as a result of the injection molding of the soft component 18, a peripheral sealing lip 64 or an O-ring is formed on the forward-pointing extreme end of the cover 70, permitting a closure cover to be fitted in a waterproof manner.

Penetration of the soft component 18 into the central cavity 29 from below is prevented by the contact pin 46, which is connected to the end of the short electrical line 42 and closes the aperture 56. The contact pin 46 is supported during the injection molding of the soft component by the aforementioned mold core of the injection mold, said mold core being introduced into the cavity.

The functions of the soft-elastic material (overmolding of functional components, vibration damping, switching region, surface texture, sealing, actuating zone for the changing mechanism, etc.) are preferably realized by just one material from at least one injection point. Alternatively, and preferred less for cost reasons, various functions may be realized by means of different materials, for example with different Shore A hardnesses or colors, via different injection points.

After the injection molding of the soft component 18, a switching element 36 (butterfly) is introduced into the cavity 29 from the rear (see FIG. 5a). The butterfly 36 is fixed on a carrier portion 69 of the hard component 16 simply by being fitted onto the hard component.

In a next step, an energy store 24, in particular a battery of the AAA or AA type (1.5 V) or a storage-battery assembly, is introduced from the rear into the cavity 28 provided for this purpose (FIG. 5a). A spring portion 66 formed on the rear end of the butterfly 36 serves as a length-compensating means and for the contacting of one battery terminal. Formed on the inner side of the hard component, level with the spring portion 66, are at least one, preferably three to four, elements 130, which represent a stop for the battery 24 (disposable battery or storage-battery assembly). Given this design, the spring excursion of the battery 24 can be precisely set. If the razor falls from a relatively great heights, the elements 130 prevent overbending of the spring element 66 by the battery.

As represented in FIGS. 5a-d, in a next step a cover 70 is fitted in place on the rear end of the razor body. The cover 70 is a pre-assembled subassembly which comprises an electrically conductive contact portion 72, via which, in the assembled state, electrical connection is established between the other terminal of the battery 24 on the one hand and the contact clip 48, which has previously been inserted into the recess 58 of the hard component 16 and subsequently encapsulated with the soft component 18, whereby the electrical connection of all the functional components involved is completed.

The connection between the cover 70 and the rear end of the razor body preferably takes place in the manner of a bayonet closure, which is discussed in more detail in connection with FIGS. 7a, b. Alternatively, the connection may take place for example by other suitable means, such as for example by latching or by a thread.

Subsequently, the assembly of a prefabricated exchangeable blade 200 and a corresponding holding device 202 takes place. The fastening of the holding device 202 on the head region 14 may take place in principle by any desired suitable means, such as for example plugging, latching, adhesive bonding, encapsulating or welding, in particular ultrasonic welding.

Instead of connecting the contact pin 46 to the line 42 already before insertion into the hard component 16, it may also be introduced separately in an additional assembly step.

FIG. 6a shows enlarged the region of the razor body in which the switching element (butterfly) 36 is arranged. FIGS. 6b and 6c show a partly sectioned view along the longitudinal axis in the region of the contact pin 46 and of the spring element 66, respectively. The butterfly consists of metal, preferably of nickel-plated spring steel. The butterfly 36 has two legs 40, which are connected to one another in an articulated manner at an articulation region 38. The leg 40 on the left in FIG. 6a serves for the contacting of the contact pin 46.

The other leg 40 of the butterfly 36 is provided at its end with a plug-in portion 68 (FIG. 6c), with which the butterfly 36 is pushed over a cross-sectionally dovetail-like carrying portion 69 of the hard component 16 for fixing on the razor body. Tooth-like projections on the plug-in portion of the butterfly become wedged together with the carrying portion formed from the hard component. The plug-in portion 68 of the butterfly 36 is adjoined by the already mentioned spring portion 66 for the contacting of one terminal of the battery 24. An extended spring portion 66, as in FIG. 5a, can be used to compensate for differences in length between disposable batteries and a storage-battery subassembly.

Activation of the legs 40 via the switching projections 31 formed on the switching membrane 30 allows the butterfly 36 to be changed over between two dimensionally stable states, in order in this way to switch the razor on and off. For example, starting from the on state represented in FIG. 6a, activation of the leg 40 on the right in FIG. 6a has the effect that the articulation region 38 moves downward, whereby, as from a certain pressed-in-depth, the butterfly 36 snaps over and the left leg 40 springs upward and thereby breaks contact with the contact pin 46. The same applies correspondingly in the case of activation of the leg 40 on the left in FIG. 6a for switching the razor on. The snapping over of the butterfly 36 is assisted by arms 67, which run parallel to the leg 40 on the right and are connected to the other leg 40 on the left in FIG. 6a. For the same reason, a ramp (not represented) is additionally formed from the hard component as an extension of the carrying portion under the butterfly.

The enlarged detail represented in FIG. 6b shows in particular the electrical connection established by means of the contact pin 46 between the free end of the short electrical line 42 and the leg 40 of the butterfly 36. The long electrical line 44 routed past the head of the contact pin 46 can also be seen.

FIGS. 7a, b show a side view and a plan view, respectively, of the rear end of the razor body. In FIG. 7b, the position of the recess 58 provided for the U-shaped contact clip 48 can be seen in particular. FIG. 7a shows how, by means of the contact clip 48 introduced into the recess 58, an electrical connection is established between the free end of the long electrical line 44 and the contact portion 72 of the cover 70, which is not otherwise represented here.

The contact portion 72 of the cover 70 comprises a contact head 73, which is preferably resilient with respect to the cover, for the contacting of the battery 24, and a contact tongue 74, which projects radially beyond the cylindrical carrying portion 71 (FIG. 5a) and by which the contact portion 72 is held. The contact tongue 74 serves on the one hand for the contacting of the contact clip 48 and on the other hand for the locking of the cover on the razor body in the manner of a bayonet closure, in that the contact tongue 74 engages behind the legs of the U-shaped clip 48. The contact portion comprising the contact head and the contact tongue is preferably formed in one piece and consists of metal, preferably of nickel-plated spring steel. The contact portion is sunken in the cover in such a way that the contact head can only perform a limited spring excursion. After a certain, authorized spring excursion, the battery is up against the cover. Consequently, here too, as in the case of the butterfly, there is a limitation of the spring excursion, which prevents the possibility of the spring head being excessively deformed if the razor falls from a relatively great height.

FIGS. 5c, d show a preferred design of a razor according to the invention, produced by the method of the invention, in various views. In the rear view of FIG. 5d are functional regions 60, which are produced in particular by injection molding of the soft component 18 and, apart from serving as a design feature, serve for vibration damping and/or make the razor according to the invention particularly good to grip. The functional regions serving partly as a hand rest or finger rest with a vibration-damping effect 60 are arranged in the example represented on the rear side in the handle region 10, level with an intermediate region between the vibration-damping region 32 and the switching region 30. A further functional region 60 surrounds the two switching points 86, 88 on the front side.

The vibration-damping region 32 formed by the hard component and the soft component together in the region of the transition between the handle region 10 and the neck region 12 can also be seen, and in this preferred design example has an annular geometry. By being designed in this way, particularly good torsion, flexibility and damping properties can be achieved.

As the representations reveal, the razor according to the invention—although an electrically operated razor—has an attractive elegant shaping, without disruptive thickened portions or awkward regions. In particular, the razor according to the invention is provided with a neck region 12 which is particularly attractively curved from an esthetic point of view and tapers with respect to the handle region. Such a slender design is made possible by the production method according to the invention, without resulting in concessions having to be made with regard to outlay and the amount of time required for producing the razor.

FIGS. 8a, b respectively show in side view and front view the pre-assembled subassembly 82, comprising the vibration device 20 with sleeve 23, two lines 42, 44, the contact pin 46 connected to the short line 42, and the contact clip 48 connected to the long line 44. The sleeve 23 is closed by cover 23′. Lines 42, 44 are routed to the outside through clearances in the cover 23′. The motor subassembly 82 is assembled, for example soldered, before the injection molding of the soft component 18 and is arranged on the previously injection-molded hard component 16.

FIGS. 9a-c show a further razor according to the invention with a rechargeable energy store 24 (storage battery) and a contact element 206. The energy store 24 and the contact element 206 are provided on a printed circuit board 210, which is arranged in the rear cavity 28 of the handle region 10. The storage-battery subassembly represented in FIGS. 10a, b, comprising the energy store 24, the contact element 206, the resistor and the printed circuit board 210, replaces the battery described above, with the construction of the razor otherwise unchanged. In particular, the shape and production of the body with a hard component 16 and soft component 18, motor subassembly with vibration device 20 and lines are unchanged.

The printed circuit board 210 has means 214 which allow a form-fitting and force-fitting connection to the hard component of the electric razor. In the present case, resilient snap lugs 214 (FIG. 10b) engage behind the contact clip 48. The printed circuit board 210 has a thickness of 0.5-3 mm, preferably 1 mm. In a preferred design variant, the printed circuit board 210 with the components mounted on it is introduced from the rear into the interior space 28 of the electric razor.

The difference in length between the conventional battery and the storage-battery subassembly 212 can be compensated by resilient connecting elements 66 of different lengths. This allows the same body, the same production tools and largely the same production steps to be used in an advantageous way.

The contact element 206 in the form of a standard socket is fastened in a form-fitting manner on the printed circuit board 210 by an anchoring element. The storage-battery subassembly 212 is pushed into the cavity 28 in the handle part 10. The cover 70 together with a seal 216 serves as a sealing element with which the cavity 28 is sealed during normal use of the razor against ingress of water and other foreign matter, as represented in FIG. 9a. FIG. 9b shows the opened state, in which the contact element 206 is accessible for a plug 218 of a power supply unit 220 (FIG. 11). The cover 70 is fitted in place in the manner of a bayonet, screw or snap-action closure and is optionally connected by means of a film hinge 222 to a fastening ring drawn over the razor body (FIG. 9b).

The cavity 28 may be covered in the opened state only by a shield (not represented), which has no sealing function. Since ingress of water would thereby be possible during charging, it is ensured by the following measures that operation of the functional unit 20 is possible only in the closed, sealed state, irrespective of the position of the switching element 36: as represented in the basic circuit diagram in FIGS. 12a-c, connected in series with the switching element 36 to be manually actuated is a further switch 224, which is formed by the contact portion 72 in the cover 70 together with the contact clip 48 in the handle region 10. The contact portion 72 establishes in the closed state an electrically conductive connection between the pin 208 of the contact element 206 and the contact clip 48, whereby the functional unit 20 is made operationally ready in principle. When the contact element 218 of the power supply unit has been inserted, the contact clips 48 are contacted only by non-conductive components of the power supply contact element 218, with the result that the switch 224 is open.

In the cover 70 there is an opening 226 and a membrane 228, through which gases produced during operation can escape, but which forms adequate protection against water.

The storage-battery subassembly 212 is mounted flexibly in the axial direction by means of a spring element 66. In the radial direction, damping elements are preferably molded from the soft component onto the hard component (not represented). The contact portion 72 and the pin 208 of the socket 206 are arranged in such a way that the contact portion 72 comes into contact with the pin 208 with prestressing when the bayonet closure is rotated. The pin 208 of the socket preferably lies on the axis of rotation of the cover 70.

The cover 70 is produced from a hart or soft component or from a combination of them. The fastening ring, if there is one, is preferably produced in one operation with the cover and preferably consists of the same material as the other soft component parts. It is of a flexible and elastic design, to allow the rotation for closing/opening the interior space to be accommodated without damage. In order that no impressions are left on the surface of the user's hand during use, the connecting crosspiece 222 between the holding ring and the cover 70 is preferably provided laterally or on the underside of the electric razor.

In a variant of the invention that is not represented, the enlarged cover 70 takes up a significant proportion of the handle region 10 and accommodates the energy store 24. The contact element 206 is positioned approximately in the center of the handle region 10, in the cavity 28 then formed by the actual body (first housing part) and the cover 70 (second housing part). The first and second housing parts are screwed to one another via a thread. The distance by which the cover 70 opens is limited by suitable means. The cover 70 can consequently be opened by rotation over a limited distance for the charging operation, complete removal by the user not being envisaged. The distance corresponds at least approximately to the size of the contact element 206. The contact element 218 of the power supply unit 220 is inserted into the contact element 206, on the front side of the razor, perpendicularly in relation to the longitudinal axis of the razor. Alternatively, a sliding closure which snaps in on the handle region 10 could also be provided.

In the case of this variant also there is preferably a switch which is automatically closed when the cover 70 is closed. A bent spring part, which is pressed by the cover against a storage-battery terminal and consequently acts as a switch, is preferably attached to the end of the printed circuit board. For this purpose, the cover has on its inner side a protuberance which is arranged on the longitudinal axis and, in the closed state, presses on the spring part irrespective of the rotary position.

FIG. 11 shows a sales set, in which the razor and power supply unit 220 are presented in a see-through pack.

FIGS. 12a-c show a basic circuit diagram for a rechargeable wet razor according to FIGS. 9a-c. In normal operation (FIG. 12a), the cover 70 seals the interior space 29 in a waterproof manner. A switch 224, which is actuated by the fitting/removal of the cover 70, is closed. The consuming unit 20 can be switched on and off by the user by means of a further switch 230. When the cover 70 is removed, the switch 224 inevitably switches off the connection between the storage batteries 24 and the consuming unit 20 (FIG. 12b). In the open, i.e. not sealed, state, the electric razor can consequently no longer be switched on. When the storage battery 24 is charged by inserting the plug 218 into the socket 206, the interior space 29 is open. By providing the switch 224, it is then additionally possible to achieve the effect that charging of the storage battery 24 can only ever take place, irrespective of the state of the switch 230, if the consuming unit 20 is not operating. This is so because, if the consuming unit 20 were operating during the charging of the storage battery 24 (i.e. 230 and 224 closed) and the storage battery 24 were completely depleted, charging would be impossible.

FIG. 13 shows, merely in a schematic form, a plan view of an assembly installation which is used for the production according to the invention of the razor designed according to the invention and by means of which largely automatic handling and assembly/fitting of individual components can take place. It is possible here to provide both a rotary-table and a transfer-installation arrangement. Use is made of two or more injection-molding machines, which are preferably provided with vertical subassemblies for injection molding the hard component and/or the soft component of the razor body. The basic body, comprising the hard component, is preferably produced on a separate injection-molding machine and presented to the assembly installation as an individual part. The injection-molding installation for encapsulating the functional components and the hard component is integrated in the assembly sequence. The speed and number of cavities of the circulating pallet of the assembly installation are made to match the number of cavities of the encapsulating station (preferably the same number of cavities). The basic bodies provided with the motor subassembly are preferably placed into and removed from the injection-molding machine automatically (handling robot). When the basic bodies are placed in, a centering device is provided (externally or by means of the injection mold), in order to obtain the same conditions for all the body cavities to be encapsulated (for example 6 of them).

The production steps are as follows (beginning at the bottom right, proceeding counterclockwise):
1. Injection molding of the hard component 16
2. Placing of the pre-assembled subassembly 82 into the hard component 16
2.1 Pressing in of the contact pin 46 and the contact clip
3. Injection molding of the soft component 18
4. Assembly of the switching element (butterfly) 36 (with spring 66)
4.1 Functional test
5. Assembly of the battery 24 or of the storage-battery subassembly 212
5.1 Pre-assembly of the closure cover 70
6. Assembly of the closure cover 70
7. Assembly of the prefabricated holding device and the exchangeable blade 200
8. Packing with or without power supply unit

As a departure from the procedure described, a different sequence of the production steps may also be provided, in particular depending on the actual design of the razor.

FIGS. 14a-c show various views of a further wet razor with a handle region 10, a head region 14 and a neck region 12 lying in between. FIGS. 15-17 show longitudinal sections of such a wet razor to illustrate different ways of producing it. The wet razor is largely identical to the razor already explained, so you are referred to the statements made above and only the differences are discussed. The differences concern the shape and arrangement of the vibration device 20 in the body. In the case of this example, the vibration device 20 is arranged in the head region 14, in the region of the holding device 202 for the exchangeable blade 200. This arrangement allows the neck region 12 to be made shorter in comparison with the examples from FIGS. 1-5. The neck region is not necessarily spatially delimited from the head region and the handle region. The holding device 202 may extend over the entire head region 14. It has a snap-action or latching mechanism 240 for the latching in of the exchangeable blade 200.

The vibration device is preferably of a relatively small form, to allow it to be arranged in the head region. For example, the dimensions in the direction of the longitudinal axis L1 of the head region are at most 20 mm, perpendicularly thereto at most 8 mm. The longitudinal axis L1 of the head region may be inclined with respect to the longitudinal axis L of the handle region.

The use of a so-called coin motor, referred to hereafter as a flat-frame motor, as the vibration device makes it possible for the wet razor to be particularly compact. In the case of such a vibration device, the motor and the flywheel arranged eccentrically in relation to the axis of rotation D (eccentric) are arranged in a flat, cylindrical sleeve 246. The height H of the sleeve 246, measured in the direction of the axis of rotation, is less than the width B, measured perpendicularly thereto. Motors from the company K'OTL Jinlong china (Nos. C1234L38, C1034L50, C1030L1-50) may be used for example. These have dimensions of B-10-12 mm and H=3-4 mm. The longitudinal extent is therefore less than the typical eccentric motors, as shown for example in FIG. 3a. The longitudinal extent there is 12-20 mm.

The advantage of such flat-frame motors is also that, by contrast with the eccentric motors shown and described above, the axis of rotation of the eccentric runs in the direction of the smallest extent. In the case of the wet razor according to the invention, an arrangement of the axis of rotation D perpendicularly in relation to the longitudinal axis L1 of the head part can consequently be realized, as shown in FIGS. 15-17. The head part consequently vibrates substantially radially in relation to the axis of rotation. This achieves the effect that the exchangeable blade vibrates in such a way that the cutting edges 244 of the shearing blades 242 move substantially in the plane E, which is defined by the cutting edges 244. When there is a movement of the razor in this plane E and perpendicularly in relation to the cutting edges 244, a gentle circulating massage of the skin therefore takes place. By contrast, in the case described above with a conventional eccentric motor, with an axis of rotation in the longitudinal direction of the head, the exchangeable blade also moves perpendicularly in relation to the skin. The cutting action is enhanced by this “beating”.

In both variants of the vibration device, the production method already described can be used. For the case of a flat-frame motor, this is shown in FIG. 15: a front cavity 50, which merges directly with a channel 52 on the underside of the body, has been hollowed out in the head region. The pre-assembled motor subassembly 82, comprising the flat-frame motor 20, connecting lines 42, 44t contact pin 46 and contact clip 48, is inserted into the cavity 50 or channel 52 and encapsulated with the further plastic component. The internals of the flat-frame motor are protected by the sleeve 246.

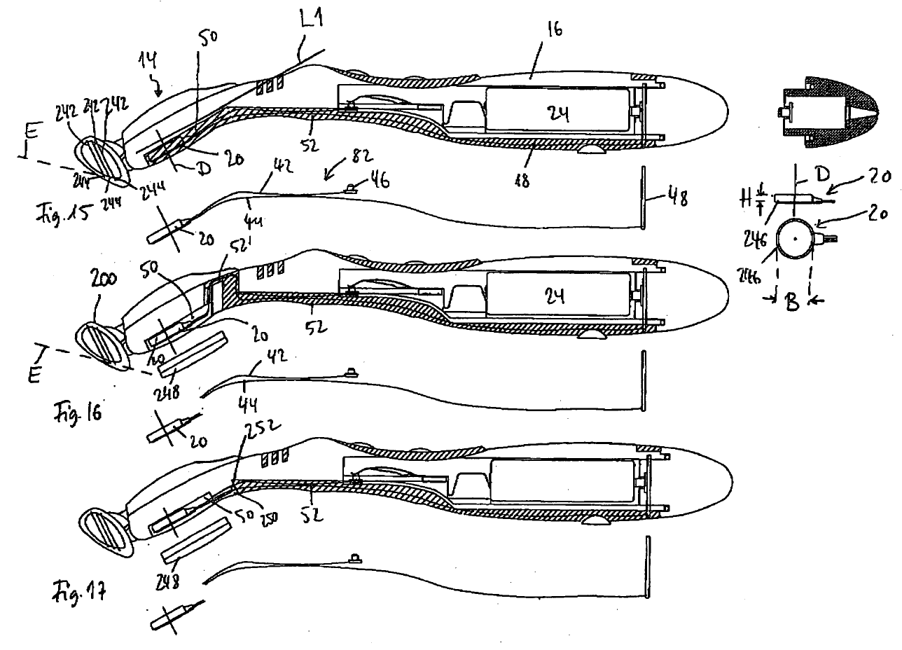

FIG. 16 shows a razor which has been produced by an alternative method. The cavity 50 for the flat-frame motor is connected to the channel 52 by a U-shaped channel piece 52′. The connecting lines 42, 44 are drawn through this U-shaped channel piece 52′ before the injection molding of the further component 18, without previously being connected to the vibration device. The further component 18 is subsequently injection molded, the cavity 50 being sealed by suitable means. Subsequently, the vibration device 20 is connected to the ends of the lines, and the cavity 50 is closed by a cover 248, for example by thermal welding or ultrasonic welding. Alternatively, the cavity 50 may be filled by a separate medium, for example synthetic resin or silicone.

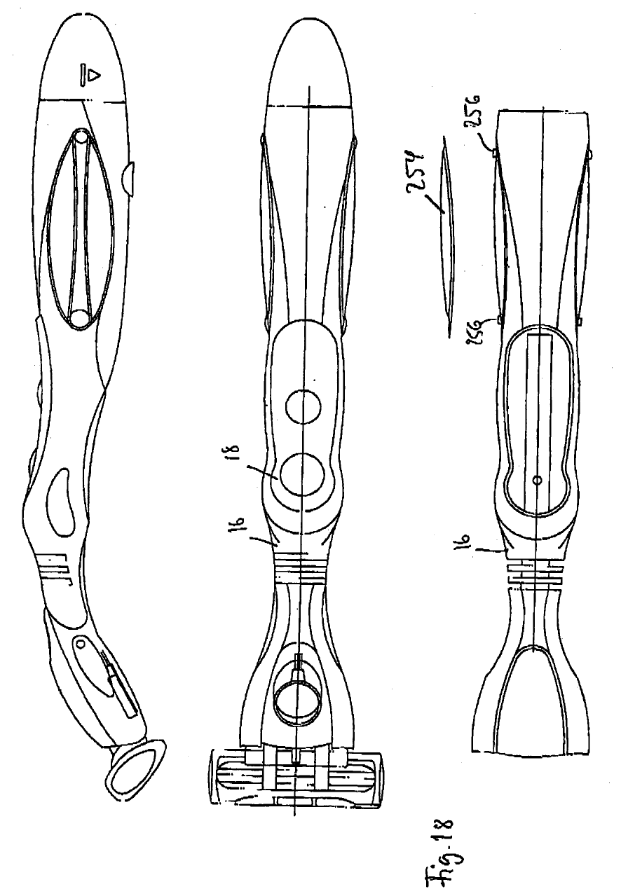

FIG. 17 shows a modification in which the cavity 50 is separated from the channel 52 by a material bridge. 250 comprising a hard component. This has a hole 252, through which the ends of the lines can be passed after the injection molding of the hard component. After the injection molding of the further component, the ends of the lines are connected to the vibration device 20. The cavity 50 is closed again by a cover 248.

FIG. 18 shows various views of a razor with an additional decorative element (shield) 254 in the handle region. The shield is made, for example, of metal, wood or plastic. It is produced in a separate step and pre-assembled on the hard component by means of fixing elements 256, which were formed during the production of the hard component 16. The fixing elements 256 are, for example, pins, grooves, means of rear engagement. In the same operation as the motor subassembly, the decorative elements 254 are also fixed on the hard component and subsequently at least partly overmolded with the soft component 18, together with the motor subassembly. The forming of further design elements from the soft component is possible, for example design elements running transversely over the shield 254 for additionally holding the shield 254. By overmolding the edge region of the shield 254, ingress of water behind the shield 254 is prevented.

1. A razor, in particular for wet shaving, with a body comprising a handle region (10), a head region (14) and a neck region (12) located between the handle region (10) and the head region (14), and with functional components which are at least partly arranged within the body and comprise an electrically operated vibration device (20) for producing vibrations in the head region and an electrical supply device, having an energy store (24), for the vibration device (20), wherein the body comprises at least one hard component (16), serving as a reinforcement, and at least one further plastic component (18), produced by the injection-molding process, at least some of the functional components being at least partly encapsulated directly with the further plastic component (18).

2. The razor as claimed in claim 1, wherein the further plastic component (18) is a soft component.

3. The razor as claimed in claim 1, wherein the hard component (16) consists of a plastic, produced in particular by the injection-molding process, or a metallic material, which is preferably involved in the electrical circuit of the supply device.

4. The razor as claimed in claim 1, wherein the functional components are arranged in the region of the boundary zone between the hard component (16) and the further plastic component (18).

5. The razor as claimed in claim 1, which comprises a cavity (28), which is formed in the hard component (16), in the handle region (10), and the dimensions of which are adapted to the dimensions of the energy store (24), in particular a battery or a storage-battery subassembly (82).

6. The razor as claimed in claim 5, wherein the functional components seal the cavity (28) with respect to the further plastic component (18).

7. The razor as claimed in claim 5, wherein the cavity (28) has at the end of the body remote from the head region an opening which can be closed by a cover element (70).

8. The razor as claimed in claim 7, wherein the cover element (70) can be removed entirely or partly, in particular to exchange the energy store (24) or to gain access to the energy store (24) for the purpose of re-charging.

9. The razor as claimed in claim 1, wherein functional components are connected to one another by means of a flexible electrical line (42, 44), preferably a metal wire.

10. The razor as claimed in claim 1, wherein the vibration device (20) is arranged in the neck region (12) and is at least partly encapsulated with the soft component.

11. The razor as claimed in claim 1, wherein a vibration-damping region (32) is arranged between the vibration device (20) and the handle region (10).

12. The razor as claimed in claim 1, wherein the supply device comprises a rechargeable energy store (24) and at least one contact element (206).

13. The razor as claimed in claim 12, wherein the energy store (24) is arranged within a cavity (28) in the handle region (10), the cavity (28) being sealed by a sealing element, in order to prevent contact of the energy store with splash water and other foreign matter.

14. The razor as claimed in claim 13, wherein the energy store (24) and the least one contact element (206) are arranged within the cavity (28), the cavity (206) being closable and able to be opened at least to the extent that the at least one contact element (206) is accessible from the outside, at least for the charging operation.

15. The razor as claimed in claim 13, wherein the cavity (28) is formed in a first housing part and can be closed by a second housing part, formed in particular as a cover (70), the first and second housing parts preferably being screwed to one another, in particular by a thread with distance limitation.

16. The razor as claimed in claim 15, wherein a switch (224) by which the vibration device (20) is deactivated in the open position of the housing parts interacts with the second housing part.

17. The razor as claimed in claim 16, wherein the switch (224) comprises the contact element (206) and a part (72) that is movable in relation to the latter, the movable part (72) entering into an electrically conductive connection with the contact element (206) in the closed position.

18. The razor as claimed in claim 12, wherein the contact element (206) has a pin (208), which is connected in an electrically conductive manner, preferably directly, to a terminal of the energy store (24).

19. The razor as claimed in claim 12, wherein the at least one contact element (206) is arranged within a clearance in the razor body, with the result that it is offset inward in relation to the outer surface of the razor body, the clearance preferably being oriented away from the head region.

20. The razor as claimed in claim 19, wherein the shape of the clearance is adapted to the shape of a further contact element of a power supply unit for the energy store.

21. A method for producing a razor, in particular a wet razor, as claimed in claim 1, in which
the body is produced from at least one hard component (16), serving as a reinforcement, and at least one further plastic component (18), molded on by the injection-molding process,
and at least some of the functional components are at least partly encapsulated directly with the further plastic component during the production of the body.

22. The method as claimed in claim 21, wherein a soft component is used as the further plastic component (18).

23. The method as claimed in claim 21, wherein firstly a first component (16) is produced without functional components and then at least some functional components are positioned and fixed on the first component (16), the unit made up of the first component and the functional components subsequently being at least partly encapsulated with at least one further plastic component (18).

24. The method as claimed in claim 23, wherein the functional components that are at least partly encapsulated with the further plastic component (18) comprise the vibration device (20), the electrical lines (42, 44) and preferably also at least one contact pin (46) for establishing an electrically conductive connection with the energy store.

25. The method as claimed in claim 21, wherein at least some functional components are arranged on the already produced hard component (16) in such a way that, in relation to the direction of flow of the further plastic component (18) that is still to be injection-molded, at least certain regions of the functional components are located in the shadow of at least one protective portion of the hard component (16).

26. The method as claimed in claim 21, wherein the functional component or a subassembly of functional components which extends over a substantial part of the length of the body is encapsulated.

27. The method as claimed in claim 21, wherein at least the hard component (16) is provided with a holding or fixing region for one or more electrical lines (42, 44), which preferably runs in the longitudinal direction and is preferably formed in the manner of a groove.

28. The method as claimed in claim 21, wherein a first housing part is produced with at least one cavity (28), which is intended for one or more functional components to be inserted later, in particular the energy store, and has, preferably at the end of the body remote from the head region, an opening for the insertion of the corresponding functional components.

29. The method as claimed in claim 28, wherein a second housing part (70) is produced for sealing the cavity and, after the insertion of functional components into the cavity (28), is fitted in place on the opening of the latter, preferably in a sealing manner.

30. The method as claimed in claim 21, wherein an actuating region which can be pressed in for actuating at least one electrical functional component, in particular a switching region (30) for activating a switching element (36) for switching the razor on and off, is formed by injection molding of the further plastic component (18), preferably the soft component.

31. The method as claimed in claim 21, wherein a vibration-damping region of the body, located in particular in the neck region (12) or in the region of the transition between the neck region (12) and the handle region (10), is formed from at least two different material components (16, 18).

32. The method as claimed in claim 31, wherein, for forming the vibration-damping region (32), the hard component (16) is produced with a pattern of recesses (34), and in that the recesses (34) are subsequently filled during the injection molding of the soft component (18).

33. The method as claimed in claim 21, wherein a soft component is injected at a single injection point as the further plastic component (18).

34. A razor, in particular for wet shaving, with a body comprising a handle region (10), a head region (14) and a neck region (12) located between the handle region (10) and the head region (14), and with functional components which are at least partly arranged within the body and comprise an electrically operated vibration device (20) for producing vibrations in the head region and an electrical supply device, having an energy store (24), for the vibration device (20), the head region having a holding device for an exchangeable blade and the vibration device being arranged in the region of the holding device.

35. The razor as claimed in claim 34, wherein the vibration device comprises a motor with a flywheel arranged eccentrically in relation to an axis of rotation.

36. The razor as claimed in claim 35, wherein the vibration device is arranged in the body in such a way that the vibration of the vibration device during use produces a movement of the cutting edges of the shearing blades of the exchangeable blade, which runs substantially in the plane defined by the cutting edges.

37. The razor as claimed in claim 35, wherein the vibration device is arranged in the body in such a way that the vibration of the vibration device during use produces a movement of the cutting edges which runs substantially perpendicularly in relation to the plane defined by the cutting edges of the shearing blades of the exchangeable blade.

38. The razor as claimed in claim 35, wherein the vibration device is arranged in the body in such a way that the axis of rotation forms an angle of at least ±60° with a longitudinal axis of the head region, preferably is perpendicular to this longitudinal axis of the head region.

39. The razor as claimed in claim 35, wherein the vibration device is arranged in the body in such a way that the axis of rotation forms an angle of at most ±30° with a longitudinal axis of the head region, preferably is perpendicular to this longitudinal axis of the head region.

40. The razor as claimed in claim 35, wherein the motor and the flywheel are arranged within a sleeve, the extent of which along the axis of rotation is less than its extent perpendicular to the axis of rotation.

41. The razor as claimed in claim 35, wherein the motor and the flywheel are arranged within a sleeve, the extent of which along the axis of rotation is more than its extent perpendicular to the axis of rotation.

42. The razor as claimed in claim 34, wherein the vibration device is arranged in a recess in the head region, in the region of the holding device.

43. A method for producing a razor, in particular a wet razor, as claim 1, in which
a body with a handle region, a head region and a neck region lying in between is produced from at least one hard component, serving as a reinforcement, and at least one further plastic component, molded on by the injection-molding process;
during the production of the body, a recess for a vibration device is produced in the hard component, in the head region;
connecting lines for establishing an electrically conductive connection between the vibration device and an energy store of an electrical supply device are laid to the hard component and encapsulated with the further plastic component during the production of the body; and
the vibration device is inserted into the recess and connected to the connecting lines, and the recess is closed.
